(19) United States
(12) Patent Application Publication
(10) Pub. No.: US 2021/0025667 A1
(43) Pub. Date: Jan. 28, 2021

(54) Separate-loading Firearm with Resistive Ignition

(71) Applicant: Murray F Feller, Micanopy, FL (US)

(72) Inventor: Murray F Feller, Micanopy, FL (US)

(21) Appl. No.: 16/517,780

(22) Filed: Jul. 22, 2019

(51) Int. Cl. F41A 19/69; F41A 19/60; F41A 9/37; H05B 1/02

(52) U.S. Cl. CPC F41A 19/69; H05B 1/0288; F41A 9/375; F41A 19/60

(57) ABSTRACT

A separate-loading firearm, which may be configured as a muzzle-loading pepperbox pistol, uses a battery-powered electric resistance heating element to ignite a propellant. A relatively long current pulse, which may be of controllable duration, is used to ignite the propellant and a much shorter pulse may be used to test the integrity of the heater. Detection of the firearm's recoil may be used to terminate the relatively long firing pulse, which can increase the service life of the heating element and reduce the current drain from the battery.

### BACKGROUND OF THE INVENTION

Separate-loading firearms commonly require percussion caps or other primers that are subject to accidental discharges when handled. Moreover, these weapons generally require a user to manually cock a spring-operated hammer or striker, an operation that can be difficult for users having weak or missing fingers.

### BRIEF SUMMARY OF THE INVENTION

A preferred embodiment of the invention incorporates electric resistance heating a propellant powder to its ignition temperature to produce the rapidly expanding gas that propels a projectile outward. The firing function may be controlled by at least one finger operated trigger switch controlling an electric power source so that cocking a spring-loaded mechanism is not required as it is in conventional weapons.

One aspect of a preferred embodiment of a separate-loading firearm of the invention is that it comprises at least one electric resistance heating element disposed in a firing chamber; switching circuitry operable to selectively connect the heating element to an electric current source for a first time interval selected to heat the heating element to a temperature high enough to ignite any propellant abutting it, the switching circuitry also operable to selectively connect the heating element to the electric current source for a second time interval, shorter than the first time interval, the second time interval selected to not heat the heating element to a temperature high enough to ignite any propellant abutting it. The firearm further comprises test circuitry operable to determine if no current passed through the heating element during the second time interval and to thereupon provide an output signal indicative of failure of the heating element.

Another aspect of the invention is that a preferred embodiment may provide a firearm comprising: an electric current source connectable to a resistance heating element in a firing chamber; a recoil sensor providing an output responsive to a recoil force directed along a barrel of the firearm; and a control circuit operable to connect the current source to the heating element for a time interval having one of a selected maximum duration and a shorter duration defined by reception by the control circuit of the output from the recoil sensor.

In one preferred multi-barreled embodiment of the invention when the firearm is powered “ON”, a light visible to the shooter is illuminated to indicate that the pistol is armed and ready for firing. Each trigger lever/button press fires a projectile until all of them have been fired. The position and count of the projectiles is retained in memory so that If some projectiles have not been fired before the firearm of the invention is powered “OFF”, when that device is powered “ON” at a later time, the sequence of firing can continue where it left off until all remaining projectiles have been fired. After the spent projectiles and propellant are replaced, a count reset switch (typically accessible through a pinhole with an opened paper clip for example, or otherwise located to be conveniently accessed by the user) is momentarily activated.

A preferred embodiment of the invention provides only a short delay (typically 0.2 seconds) between the firing switch activation and the propellant powder ignition. After the propellant is ignited and the resultant gas buildup forces the projectile to move, the firearm experiences recoil. In a preferred embodiment, that recoil movement is sensed in order to immediately turn off the electrical power to the ignition heater. A preferred heater is of low mass to quickly heat and is relatively fragile. By minimizing heat cycling and mechanical stress exposure, its life is extended and reliability improved so that it can be used many times before replacement is required. This conservative use of electrical power also increases the number of firings available from an exhaustible electric power source, which is typically a battery. A particular advantage of the invention is that it does not require percussion caps or primers and is therefore safer to reload the firing chambers and less subject to accidental discharges due to impact.

Those skilled in the art will recognize that the foregoing broad summary description is not intended to list all of the features and advantages of the invention. Both the underlying ideas and the specific embodiments disclosed in the following Detailed Description may serve as a basis for* alternate arrangements for carrying out the purposes of the present invention and such equivalent constructions are within the spirit and scope of the invention in its broadest form. Moreover, different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

FIG. 1A is a partially cross-sectional, partially cut-away schematic view of a preferred embodiment.

FIG. 1B is a partially cross-sectional schematic end view of the embodiment of FIG. 1A.

FIG. 2 is a simplified block diagram of an electronic circuit for operating and testing a separate-loading firearm of the invention.

FIG. 3 is an elevational view of an igniter circuit board on which only some of the connection points have heater wires connected to them.

FIGS. 4A and 4B are, respectively, end and side views of a conical igniter.

FIG. 5 is a partial sectional view of an embodiment having replaceable firing chambers.

FIG. 6 is a partially cross-sectional, partially cut-away schematic view of a revolver embodying the invention.

FIG. 7 is a largely schematic depiction of a heater contact arrangement for a revolver made in accordance with the invention.

### DETAILED DESCRIPTION OF A PREFERRED EMBODIMENT

In studying this Detailed Description, the reader may be aided by noting definitions of certain words and phrases used throughout this patent document. Wherever those definitions are provided, those of ordinary skill in the art should understand that in many, if not most, instances such definitions apply both to preceding and following uses of such defined words and phrases. Of particular concern for this document are the terms ‘muzzle-loading’ and ‘separate-loading’ which are sometimes interchangeable. Both stand for arms that do not use fixed ammunition and in which a projectile is inserted into a firing chamber that has previously been charged with a propellant and is thus separately loaded. A large fraction of separately-loaded small-arms are loaded through the muzzle but some, notably revolvers, provide loading access at a front of a chamber or chambers.

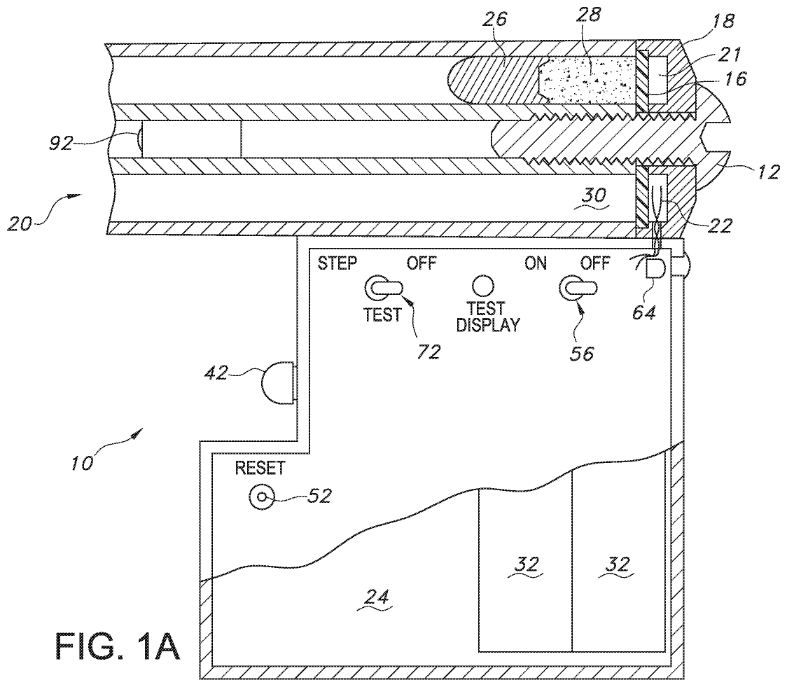

FIGS. 1A and 1B provide a largely schematic depiction of an exemplar firearm of the invention 10, which is configured as a multi-barreled pepperbox pistol. In this configuration a large screw 12 squeezes an igniter circuit board 16 between an end cap 18 and a barrel cluster 20. In some embodiments an initially empty space 21 under the cap is used for routing wires 22 connecting the igniter board 16 to a main circuit board 24. This space 21 and the wires 22 may be potted with a suitable resin to strengthen the assembly. In some embodiments a wiring harness connector 75 is provided to allow for easy connection between the igniter PCB 16 and the main PCB 24. Although the overall shape of the barrel cluster and firing chamber is shown as being generally cylindrical, the reader will recognize that various numbers and sizes of barrels may be used and the supporting electronics can readily be modified to suit. Furthermore, there is no requirement that all the projectiles 26, their propellant loading and calibers be identical on a given firearm.

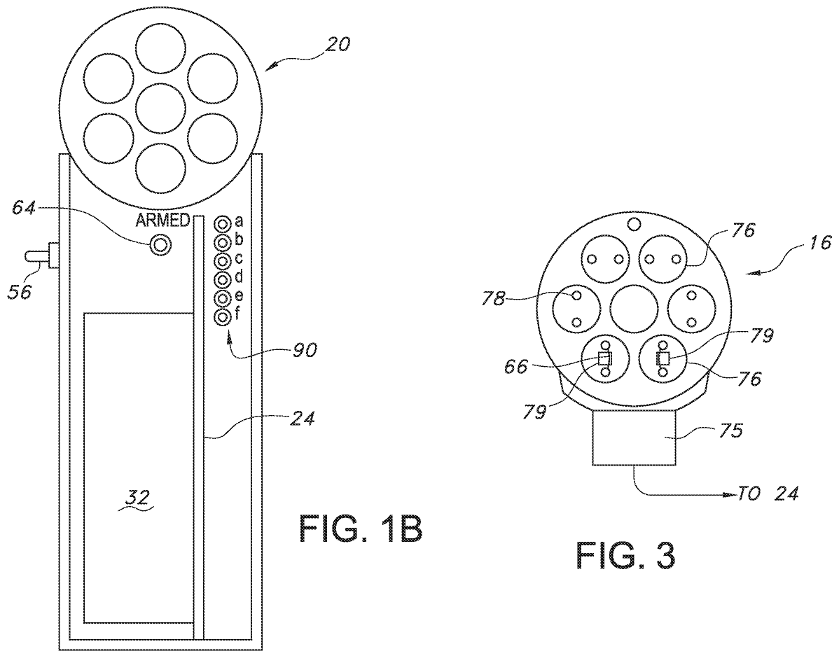

FIG. 2 shows a simplified block diagram of an electronic circuit used to ignite the propellant powder 28. In this example, a circuit board 16 is located at the end of firing chambers 30 that are integrated with respective barrels. Electrical power from a battery 32 is connected through an ON/OFF power switch 56 to a voltage regulator 36 which charges a super capacitor 38 to a designated voltage, for example 5 volts, and selectively switches current through a respective transistor 40 to the heater wire(s) 66 of a respective associated firing chamber 30. A user-operated firing switch (or switches) 42, when momentarily switched “ON” triggers a one-shot 44 to produce a pulse, typically having a duration of 200 milliseconds, which clocks a counter 46, advancing it one step through its outputs (of which six are depicted) each time the firing switch 42 is closed. Those outputs are supplied to respective AND circuits 48 along with the pulse from the one shot. The reader will recognize that a single switch 42 is adequate to initiate the firing cycle. In the depicted preferred embodiment, two series-connected switches are employed in the interest of safety as will be described subsequently herein.

The AND circuit output pulse durations are the same as that of the one shot 44. When the last chamber has been fired, a capacitor 49 transfers the trailing edge signal of the firing pulse to a latch 50 which resets the counter 46 to a zero-output state that is maintained until the latch is manually reset by a reset switch 52. Until the latch is reset, the heater wires cannot be energized. The reset is usually activated after the chambers have been reloaded or during testing. The number of output steps may be made selectable to accommodate different numbers of chambers that are employed when the circuit is used with different firearm configurations.

The battery 32 continuously powers the control portions of the circuit through a diode 54 thereby enabling those circuit elements to retain their electrical state when the power switch 56 is placed in the “OFF” position. Alternatively, a microprocessor may be used to perform all of the logic functions required and incorporate a non-volatile memory retaining all of the logic states when the power is switched “OFF”. A capacitor 58 stores charge which is isolated from the battery so that when a voltage transient occurs at the battery, as may happen when firing takes place, the voltage available to the control portions of the circuit as designated by a terminal 60, is constant.

After the power switch is placed in the “OFF” position, the super capacitor 38 is grounded through a resistor 59, thereby discharging it in a short period of time for safety. In the ON state a LED 64 is preferably connected to a signal source in the voltage regulating circuit and is readily viewable by the user when the super capacitor is fully charged (other notifying devices such as a vibrator can also be used) and that the firearm is ready to be fired. In the event the user presses the firing switch 42 before the LED is illuminated and continuously holds it in the firing position, the preferred firearm will fire immediately after the super capacitor 38 is fully charged. This enables the firearm to fire as quickly as possible after the fire switch is pressed. The various logic steps for this operation may be carried out in a preferred embodiment by a CMOS monostable multivibrator conventionally designated as a 74VHC123A.

A super capacitor has been used in the foregoing example as a supply of high current pulses to the heater wires because of peak current limitations characteristic of small long-life batteries. Note that in the future improved batteries will probably eliminate the need for those capacitors and will directly power the heater wires.

Preferred heater wires 66 are made from alloys used for resistance heating (e.g., Kanthal Al) and need to be of very small mass so that they will come up to the required ignition temperature quickly. The wires are therefore necessarily of very small diameter, for example 0.003″, and although relatively fragile, yet are still practical for this application. The wires retain much of their strength at temperatures well over 1000 degrees Celsius to comfortably serve as the ignition source. Alternately, one could consider using known thin film or thick film approaches to form low-mass heater arrays on a suitable refractory substrate.

Good ignition has been observed when a wire heater is used with a double base smokeless powder sold by Western Powders Inc. under the trade name of Accurate #9, which has an ignition temperature of about 293 degrees Celsius. The reader will note that the invention is not limited to a particular propellant and that a wide range of powder compositions and grain sizes, as well as pelletized propellants can be considered. For example, other propellants used in conventional cartridges have been used successfully

An inertial reset switch 68 is used in preferred embodiments. Reset may be initiated by an accelerometer output or may comprise a simple mechanical switch with a weighted actuator. If the firearm barrels and/or firing chambers incorporate a spring-loaded slide to suppress the recoil effect, that mechanism, when fitted with a pair of contacts or an inertially sensitive switch such as a shock, vibration or acceleration switch for example, can also be used as a reset switch. When a preferred firearm is fired, its recoil activates the switch, thereby resetting the one shot multivibrator 44 so that its output pulse is shortened. The shortened pulse reduces excess temperature rise which minimizes loss of strength in the wire at a time when the turbulent gasses produced during a firing can mechanically strain the wires. The average heated temperature of the elements is also reduced. Both factors enhance the reliability of the heated wires. The shortened pulses also reduce the usage of current from the battery so that the firearm can be fired more times before the battery needs to be replaced or recharged. The reliability of the propellant ignition may be further improved by connecting the heating wires through parallel paths, either path being capable of igniting the propellant.

An alternative to the above inertial sensing device is one that senses pressure. Examples of such devices are piezoelectric ceramics and pressure sensing resistors. These would typically be located between the cylinder and its mounting so that it is squeezed when the firearm is discharged. Alternatively, it can be weighted on one of its active surfaces while the other is anchored to a relatively stationary surface so that it is inertially squeezed during discharge.

For testing the electronic ignition system, a test mode may be incorporated which preferably uses a high frequency current transformer 70 that senses the current through heater wires 66 for each of the firing chambers when the fire switch is pressed. In this test mode, the pulse duration is very short, typically on the order of 10 to 100 microseconds, so that the temperature of the energized heater wires is raised only a very small amount, far less than that required for propellant ignition. The transformer output voltage is detected and provides a measure of the current. In an embodiment having two parallel heater wires 66 for each firing chamber if one of the wires is open, the current and hence the transformer output voltage will be one half of the correct amount. If both wires are open, the output voltage would be zero. When powered ON by the test switch 72 each counter step, as advanced by the fire switch, enables a detector 74 to detect, evaluate and display the ignition system's condition, and thereby advise the user of the firearm's condition and whether servicing is required. The display may for example, be a dual mode LED which illuminates with a green color when both heater wire paths are functional, a yellow color when only one is functional, and does not illuminate when no heater wires are functional. Alternatively, two separate LED's may be used. A low value current sensing resistor with suitable amplification may be substituted for the transformer 70.

The equivalent logic and sensing functions just described use discrete components for development and description, and can be readily duplicated with a digital processor.

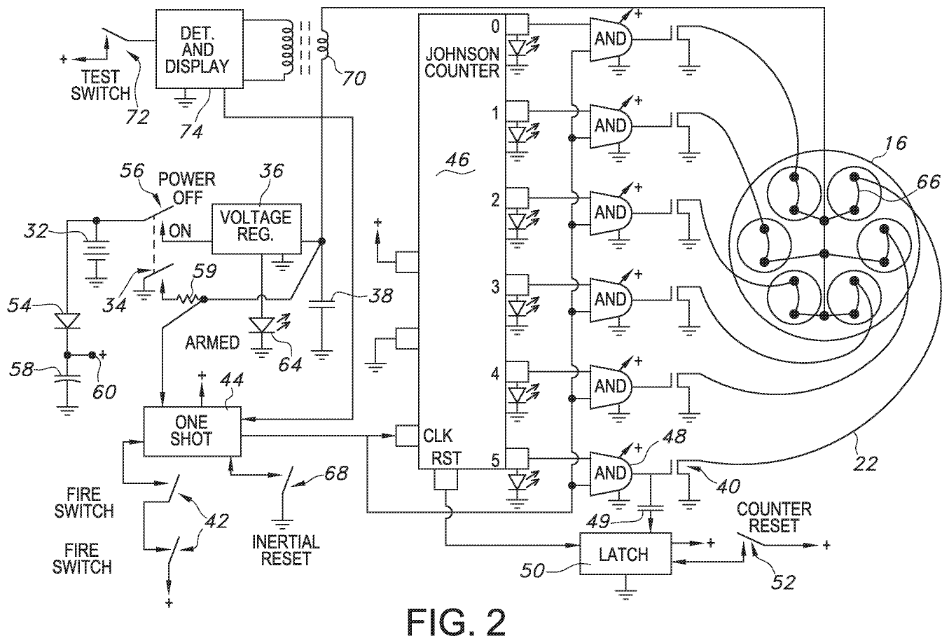

FIG. 3 depicts an enlarged example of a firing chamber 30 having heater wires 66 arranged on the top of a flat insulator, which may be a PC board 16. A gasket 76, which may be a copper ring defined during PC board fabrication, seals the chamber 30 from others on the same board so that accidental leakage of propellant gas from one chamber does not ignite the propellant in an adjacent chamber. The board 16 is preferably tightly squeezed against the firing chambers 30 by a screw 12. An insulating sheet 88, which may be polysulfone, may be used to both provide a resilient portion of the clamping arrangement and to prevent shorting the backside of the board by the metal end cap 18. A preferred double-sided board may provide a plurality of feedthrough connections 78 between aligned pads on opposite sides of the board 16. The connecting wires for energizing the heater wires can be attached to the pads on the back side of the board or PC bottom traces can be used to connect them as required. Simpler arrangements, such as welding or soldering wires to a pad on a single-sided board, are also possible.

The heater wires preferably abut a supporting surface such as an igniter PC board 16 which may provide pads 79 of thermally and electrically insulating material, such as mica, disposed between wires and the PC board. This arrangement minimizes strains in the heater wires when the propellant 28 is squeezed against the wire during reloading. Moreover, wire movement is inhibited by the board when the structure is subjected to turbulent gases during firing.

A tab portion of an igniter board can provide one side of a push-together connector 75 tying the igniter 16 and main 24 circuit boards together. This is expected to be a practical consideration in firearms in which pre-loaded barrel or chamber arrays are used.

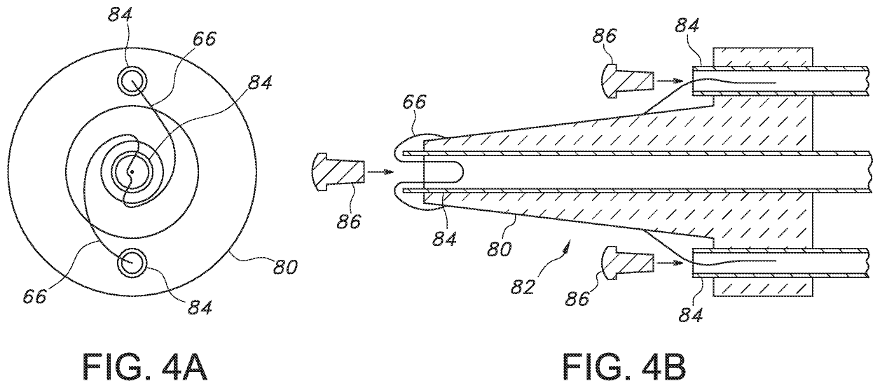

An alternate embodiment of a heater wire array is depicted in FIGS. 4A and 4B which show a slender conical igniter 82. A conical ceramic insulator 80 has a flat base suitable for mounting on a PC board 16 by inserting open or partially closed tubes 84 into the board. Pieces of heater wire are inserted into the ends of respective tubes and tapered pins 86 are pressed in place or staked to secure them. The wires may also be inserted in the tubes and soldered in place. The windings do not touch each other as shown in the end view of FIG. 4B. The circuit board supporting the igniter connects the two outer tubes together so that one of them and the center tube are the two connections to be used for energizing both heaters. This configuration offers the advantage of utilizing relatively long lengths of heater wire and having deep penetration into the propellant for the purposes of faster and more complete ignition. The two parallel interdigitated heater wires thereby provide redundancy in the event of one of them failing.

In a preferred embodiment the test switch 72, when placed in the, “STEP” position, enables the user to step through the different firing chambers by momentarily pressing on the fire switch until one short of the desired chamber is illuminated. Then the switch is switched back to its normal, “NORM” position. The next time the fire switch is pressed, the desired chamber is fired normally. LED lamps 90 connected to the counter output terminals can be used to indicate this status to the user.

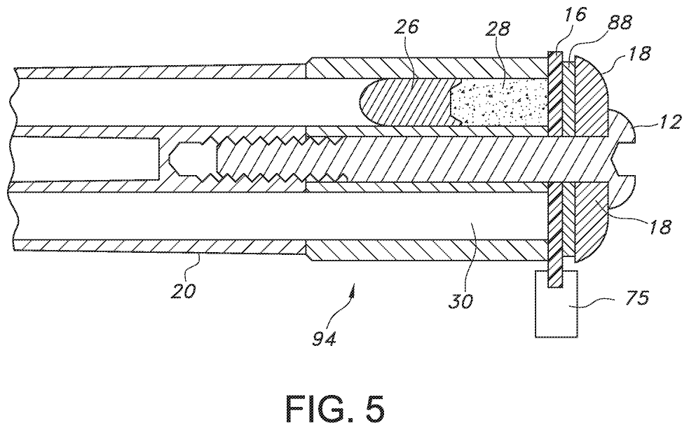

FIG. 5 depicts a barrel cluster portion of a firearm of the invention in which a pre-loaded cluster of firing chambers 94 is attached to the barrel cluster 20. In this arrangement electrical connections to the igniter board 16 are preferably made by using a multi-terminal connector 75 to facilitate replacing a used chamber cluster with a loaded one.

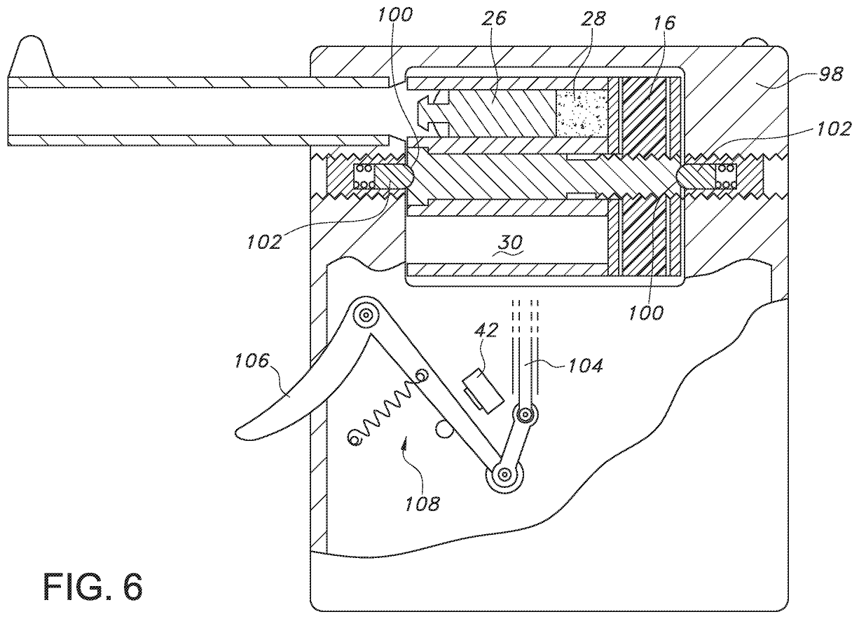

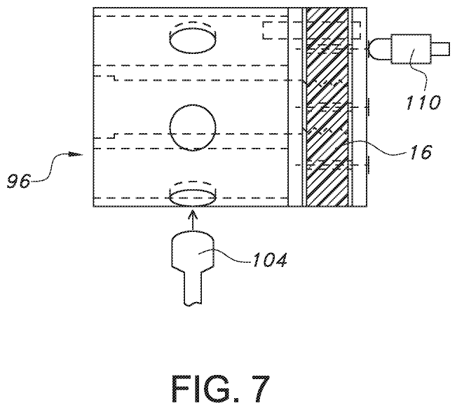

The reader will appreciate that one could also make a weapon having a chamber cluster combined with a single barrel—i.e., make a revolver rather than a pepperbox. An embodiment of a revolver of the invention is depicted schematically in FIG. 6. It incorporates a rotatable multi-chamber cylinder 96 assembly mounted in a solid frame 98 by an arrangement in which dimples 100 disposed on the axis of rotation of the cylinder assembly 96 engage spherical cap portions of respective spring-loaded plungers 102. The plungers 102 are threaded into the revolver frame at a spacing selected so that the cylinder assembly rotates freely and can be removed from the frame by having the user push the cylinder assembly laterally with both thumbs. A loaded cylinder assembly can then be inserted into the frame of the firearm with ease.

In a preferred revolver of the invention a mechanical linkage comprising a pushrod 104 coupled to a trigger 106 is used to rotate the cylinder assembly so that the chamber to be fired is in alignment with the barrel 20. Alternatively, an electric stepper or linear motor may be used. When the trigger is squeezed an associated trigger linkage 108 moves a pushrod 104 that acts on the cylinder, causing it to rotate precisely the amount required for alignment of the chamber opening with the barrel. This mechanism is similar to that in current use with conventional revolvers. The trigger also activates the firing switch 42 which can provide a stop for additional movement of the trigger, or a separate stop can be used. With a very slight additional trigger movement before the stop position is reached, the switch 42 is activated and the firearm will fire. The cylinder and/or rotation mechanism may be fitted with spring plungers or the equivalent to further define the positioning and/or with switches to inhibit firing if the cylinder is not precisely positioned. The trigger is provided with a return spring so that when pressure on it is released, it will return to its former position and be ready to engage the cylinder for its angular rotation preceding the next shot.

A spring-loaded contact connected to the firing electronics mates with a pad on the revolver igniter board when the uppermost chamber of the cylinder is aligned with the barrel. Only one of the heater wires is electromechanically selected to be energized or tested at a time, which simplifies the electronics when compared to what is used in a pepperbox embodiment.

A LED or laser diode 92 may be incorporated as an integral part of the firearm for target marking. It can operate independently of the firearm in either the continuous or flash mode, or be user programmed to operate when the firearm is turned on.

Two trigger switches 42 are preferably provided, the first being in the normal index finger location and the second being for an adjacent finger just below in another location such as in the user's normal view and operated by his thumb. Since the firearm could be fired easily as the required switch pressure can be relatively low compared to the trigger squeeze of a conventional weapon, adding a second switch operated by another finger like the thumb or palm of the hand, makes sense for safe operation. In operation, both switches are connected electrically in series and need to be closed to fire.

Although the present invention has been described with respect to several preferred embodiments, many modifications and alterations can be made without departing from the invention. Accordingly, it is intended that all such modifications and alterations be considered as being within the spirit and scope of the invention as defined in the attached claims.

1) A separate-loading firearm comprising:
at least one electric resistance heating element disposed in a respective firing chamber;
switching circuitry operable to selectively connect the heating element to an electric current source for a firing pulse interval having a duration adequate to heat the heating element to a temperature high enough to ignite an abutting propellant, the switching circuitry also operable to selectively connect the heating element to the electric current source for a test pulse interval shorter than the firing pulse interval, the test pulse interval having a duration inadequate to heat the heating element to a temperature high enough to ignite abutting propellant;
the firearm further comprising test circuitry operable to determine if no current passed through the heating element during the second time interval and to thereupon provide an output signal indicative of failure of the heating element.

2) The separate-loading firearm of claim 1 further comprising a recoil sensor having an output to the switching circuitry and wherein the switching circuitry is operable to terminate the firing pulse responsive to receiving the recoil sensor output.

3) The separate-loading firearm of claim 1 wherein the heating element comprises a metal wire abutting an igniter circuit board.

4) The separate-loading firearm of claim 1 wherein the firing pulse interval has a duration of more than 100 milliseconds.

5) The separate-loading firearm of claim 1 wherein the test pulse interval has a duration of less than 100 microseconds.

6) The separate-loading firearm of claim 1 wherein the current source comprises a battery and a supercapacitor.

7) The separate-loading firearm of claim 1 further comprising an electrical connector interposed between the at least one firing chamber and the switching circuitry, the connector operable to permit interchange of the at least one firing chamber with a second at least one firing chamber.

8) A separate-loading firearm comprising: an electric current source connectable to a resistance heating element disposed in a firing chamber; a recoil sensor providing an output responsive to a recoil force directed along a barrel of the firearm when the firearm is fired; and switching circuitry operable to connect the current source to the heating element for a firing pulse interval having one of a selected maximum duration and a shorter duration terminated by reception of the output from the recoil sensor by the switching circuitry.

9. The separate-loading firearm of claim 8 wherein the heating element comprises a metallic wire abutting a circuit board.

10. The separate-loading firearm of claim 8 wherein the maximum duration of the firing pulse is more than 100 milliseconds.

11) The separate-loading firearm of claim 8 wherein the current source comprises a battery and a supercapacitor.

12) The separate-loading firearm of claim 8 further comprising an electrical connector interposed between the firing chamber and the switching circuitry, the connector operable to permit interchange of the firing chamber with a second firing chamber.
